(19) United States
(12) Patent Application Publication
(10) Pub. No.: US 2002/0046278 A1
(43) Pub. Date: Apr. 18, 2002

(54) Method and system for global log on in a distributed system

(76) Inventors: Roy Hays, Seattle, WA (US); Billy Wayne Hensley, Garland, TX (US)

Correspondence Address: PERKINS COIE LLP, PATENT-SEA, P.O. BOX 1247, SEATTLE, WA, 98111-1247, US

(21) Appl. No.: 09/782,685

(22) Filed: Feb. 13, 2001

Related U.S. Application Data
(63) Continuation-in-part of application No. 09/619,077, filed on Jul. 17, 2000.

(51) Int. Cl. G06F 15/173

(52) U.S. Cl. 709/225; 709/229

(57) ABSTRACT

A distribution system for distributing content for a medical information collection system. The collection system comprises a collection server and multiple collection kiosks. A collection kiosk is a computer system attached to various devices for collecting medical information. The collection kiosks may be located at various locations, such as in drug stores or pharmacies. A person can use the collection kiosks to collect and store their medical information. The collection kiosks may have a user interface through which a person can enter a user identifier and password to obtain access to their stored medical information. Whenever a user wants to collect current medical information, the user would go to a collection kiosk, log on to the kiosk, and have their medical information collected and then stored.

### CROSS-REFERENCE TO ALL RELATED APPLICATIONS

This application is a continuation-in-part of U.S. patent application Ser. No. 09/619,077, entitled “METHOD AND SYSTEM FOR GLOBAL LOG ON IN A DISTRIBUTED SYSTEM” filed on Jul. 17, 2000. This application is related to U.S. patent application Ser. No. 09/654,203, entitled “METHOD AND SYSTEM FOR DISTRIBUTING WEB CONTENT,” filed on Sep. 1, 2000, 2000; U.S. patent application Ser. No. 09/654,152, entitled “METHOD AND SYSTEM FOR COLLECTING INFORMATION AT DISTRIBUTED LOCATIONS,” filed on Sep. 1, 2000; U.S. and application Ser. No. 09/654,146, entitled “METHOD AND SYSTEM FOR COLLECTING INFORMATION BEFORE USER REGISTRATION,” filed on Sep. 1, 2000, the disclosures of which are incorporated herein by reference.

### TECHNICAL FIELD

The described technology relates to distribution of user log on information in a distributed environment.

### BACKGROUND

The Internet comprises a vast number of computers and computer networks that are interconnected through communication links. The interconnected computers exchange information using various services, such as electronic mail, Gopher, file transfer protocol (“FTP”), and the World Wide Web (“WWW”). The WWW service allows a server computer system (i.e., web server or web site) to send graphical web pages of information to a remote client computer system. (In some instances, the server and client functionality can be hosted on a single computer.) The remote client computer system can then display the web pages. Each resource (e.g., computer or web page) of the WWW is uniquely identifiable by a Uniform Resource Locator (“URL”). To view a specific web page, a client computer system specifies the URL for that web page in a request (e.g., a HyperText Transfer Protocol (“HTTP”) request). The request is forwarded to the web server that supports that web page. When that web server receives the request, it sends that web page to the client computer system. When the client computer system receives that web page, it typically displays the web page using a browser. A browser is a special-purpose application program that effects the requesting of web pages and the displaying of web pages.

Currently, web pages are typically defined using HyperText Markup Language (“HTML”). HTML provides a standard set of tags that define how a web page is to be displayed. When a user indicates to the browser to display a web page (e.g., by selecting an icon representing that web page), the browser sends a request to the server computer system to transfer to the client computer system an HTML document that defines the web page. When the requested HTML document is received by the client computer system, the browser displays the web page as defined by the HTML document. The HTML document contains various tags that control the displaying of text, graphics, controls, and other features. The HTML document may contain URLs of other web pages available on that server computer system or other server computer systems. The content of a web page (e.g., graphic images) may be stored in a resource (e.g., file) that is separate from the web page. In particular, a web page may contain a URL that defines the resource that contains the content. When the web page is displayed, that URL is used to retrieve and then display the content.

Medical service providers and their patients have a need to monitor medical information (e.g., blood pressure readings) very closely in some circumstances. It is relatively easy for a medical service provider to collect and monitor medical information when the patient is at a medical facility (e.g., hospital) and possible for a patient to collect certain types of medical information while not at a medical facility. It has, however, been difficult for medical service providers and their patients to monitor medical information collected by the patients outside of a medical facility. For example, a patient may take their own blood pressure readings at home, but never provide those readings to their medical service provider or even record those readings so that trends can be tracked. Moreover, many patients may not even have the equipment in their homes for collecting such medical information. To facilitate the collection of medical information, blood pressure stations or kiosks have been installed at some publicly accessible locations (e.g., drug stores). Patients who do not have the equipment in their homes can use such publicly accessible kiosks to collect their medical information. Although these kiosks now make it possible for virtually all patients to collect their medical information, the tracking of such medical information over time is still as difficult as if the patient had collected the information at their home. Also, the kiosks may be installed at only a limited number of locations, in part, because the owners of those locations may not perceive the benefit of having such a kiosk. One benefit of a kiosk is that it may increase the customer traffic to those locations.

It would be desirable to have a system in which medical information could be easily collected by patients and stored in a way that both patients and medical service providers could monitor the medical information over time. It would be desirable to have a kiosk that would bring enhanced benefits to both owners of the installed locations and the patients. In addition, it would be desirable to have a system in which patients could have their medical information collected at any available kiosk and made available to the patients and to medical service providers via the Internet.

### BRIEF DESCRIPTION OF THE DRAWINGS

FIG. 1 is a diagram illustrating the main web page of the collection kiosk.

FIG. 2 is a diagram illustrating a blood pressure verification display.

FIG. 3 is a diagram illustrating an instructional web page.

FIG. 4 is a diagram illustrating a web page displayed while collecting blood pressure measurements.

FIG. 5 is a diagram illustrating a web page for displaying blood pressure measurements.

FIG. 6 is a diagram illustrating a web page asking whether the user is a member of Lifeclinic.com.

FIG. 7 is a diagram illustrating a web page for entry of log on information of a registered user.

FIG. 8 is a block diagram illustrating components a medical information collection system in one embodiment.

FIG. 9 is a block diagram illustrating data structures of the medical information database.

FIG. 10 is the flow diagram of a routine of the medical information server that prepares the update files for transmission to the collection kiosk.

FIG. 11 is a block diagram illustrating the tables of the database of a collection kiosk in one embodiment.

FIG. 12 is a flow diagram of a routine to retrieve the update files from the medical information server.

FIG. 13 is a flow diagram illustrating the processing of an update file.

### DETAILED DESCRIPTION

A method and system for distributing user information for registered users from a central computer system to remote computer system is provided. In one embodiment, the distribution system accesses a central repository of user information that may contain a user identifier and password for each registered user. As the information for registered users is updated in this central repository, the distribution system maintains a log file indicating each update. For example, the updates may include the adding of a new registered user, the deleting of a current registered user, and the updating of a registered user's information. Periodically, the distribution system collects the recent updates from the log file and stores indications of those updates in an update file. The distribution system then stores a copy of the update file at designated locations (e.g., directories) that are accessible to each remote computer system to which the updates are to be distributed. Each remote computer system accesses the distribution system to retrieve its copy of the update file from its designated location. The remote computer system then updates its copy of the registered user information in accordance with the retrieved update file. Once the update is complete, each remote computer system has a current list of all registered users. A user can then log on to any of the remote computer systems, which can then verify whether the user is registered.

In one embodiment, the log on information distribution system is implemented as part of a distributed medical information collection system. The collection system comprises a collection server and multiple collection kiosks (i.e., remote computer systems). A collection kiosk is a remote computer system attached to various devices for collecting medical information. For example, the devices may include a blood pressure monitor and a scale. The collection kiosks may be located at various locations, such as in drug stores or pharmacies. A person can use the collection kiosks to collect and store their medical information. The collection kiosks may have a user interface through which a person can enter a user identifier and password to obtain access to their stored medical information. Whenever a user wants to collect current medical information, the user would go to a collection kiosk, have their medical information collected, and if they want their medical information stored, then they would enter their user identifier and password.

The collection kiosks may provide a user interface that is web-based, that is uses the HTTP and the HTML protocols. The collection kiosks may use a web browser to display web pages that define the user interface. Various web pages may be provided (e.g., stored on the collection kiosk as a local web server) that allow a user to log on to the system and collect and review medical information. The distribution system controls the downloading of user information from a distribution server, which may be part of the collection server, to the collection kiosks. The distribution server may periodically (e.g., daily) generate an update file of recent changes to the list of registered users. These changes may include the adding, deleting, or changing of user information. The distribution server then makes these changes available to each collection kiosk. A collection kiosk may periodically access the distribution server to retrieve the updated user information. To retrieve the new information, a collection kiosk connects to the distribution server and transfers the information from its folder (i.e., directory) at the distributor server to the collection kiosk. In one embodiment, the distribution server may function as a file transfer protocol (“FTP”) server, and each collection kiosk may function as a FTP client. Once the collection kiosk receives the update information, it can update its local list of registered users accordingly.

The collection system may interface with a medical information web site through which a user can view their medical information using their own home computer and through which a medical provider can view their patients' information. The medical information stored at the medical information web site may include the information collected at the collection kiosks. Each collection kiosk may upload recently collected medical information to the medical information web site on a periodic basis. The uploaded medical information can then be added to a central medical information database. The central medical information database may contain the medical information collected through the collection kiosks and collected through other sources.

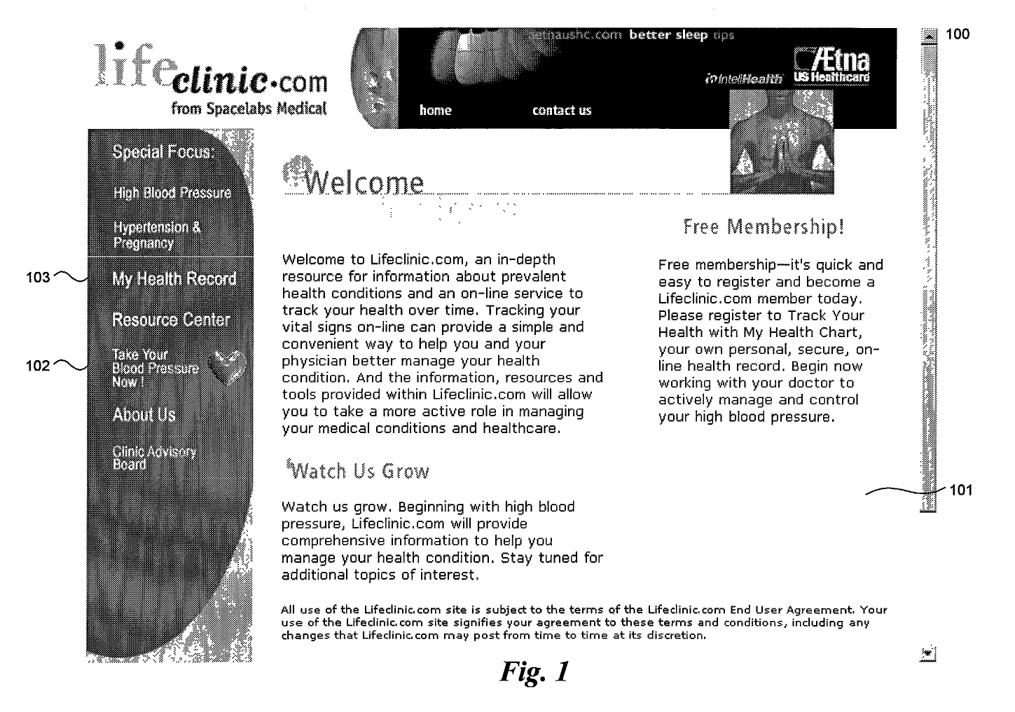

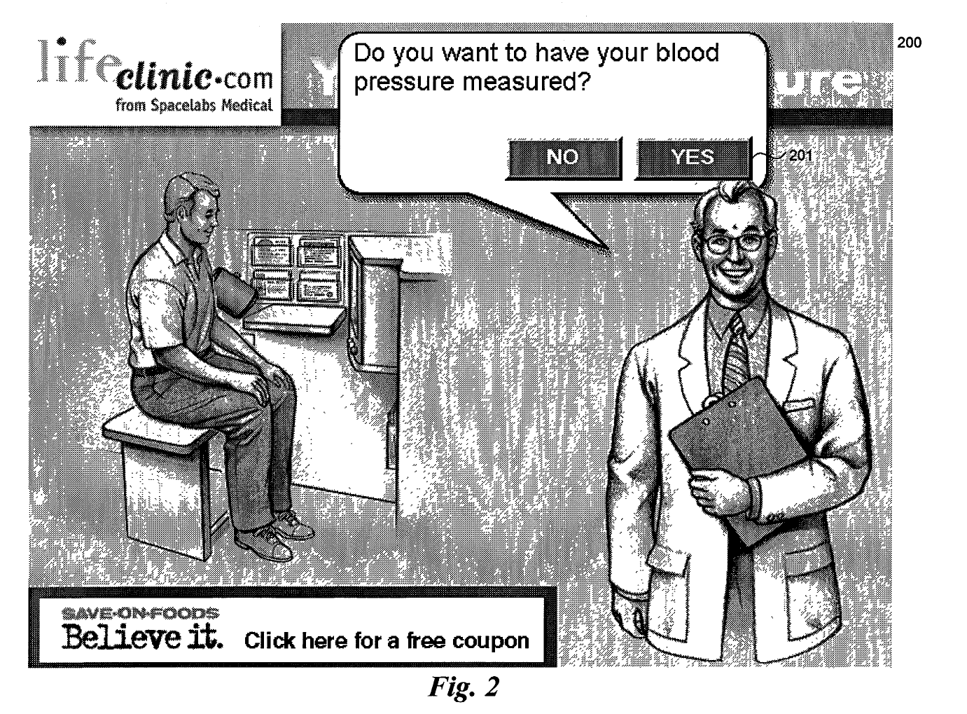

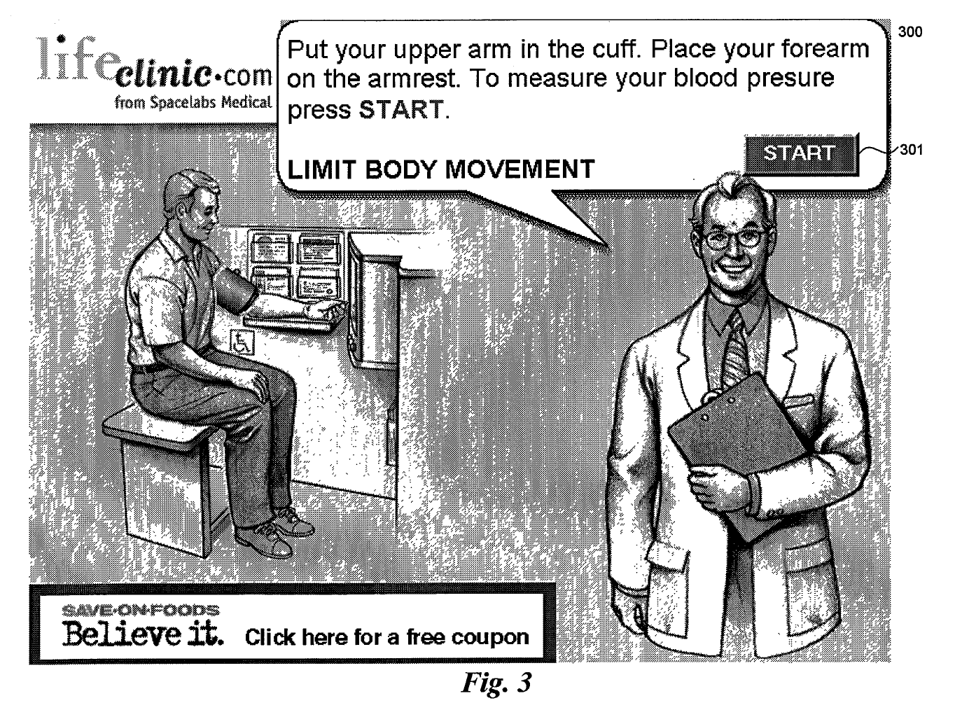

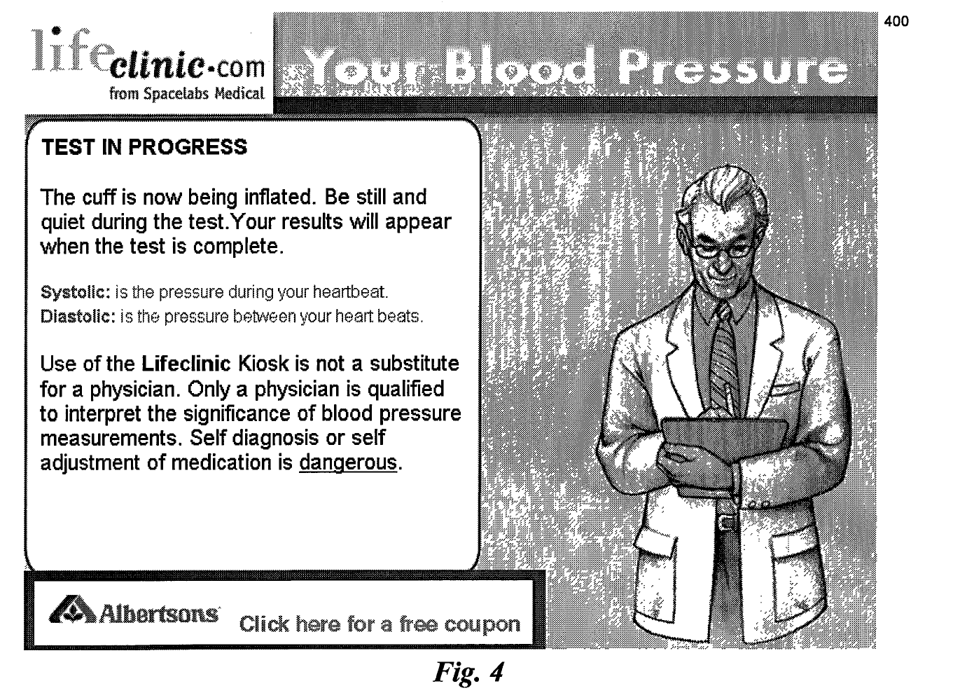

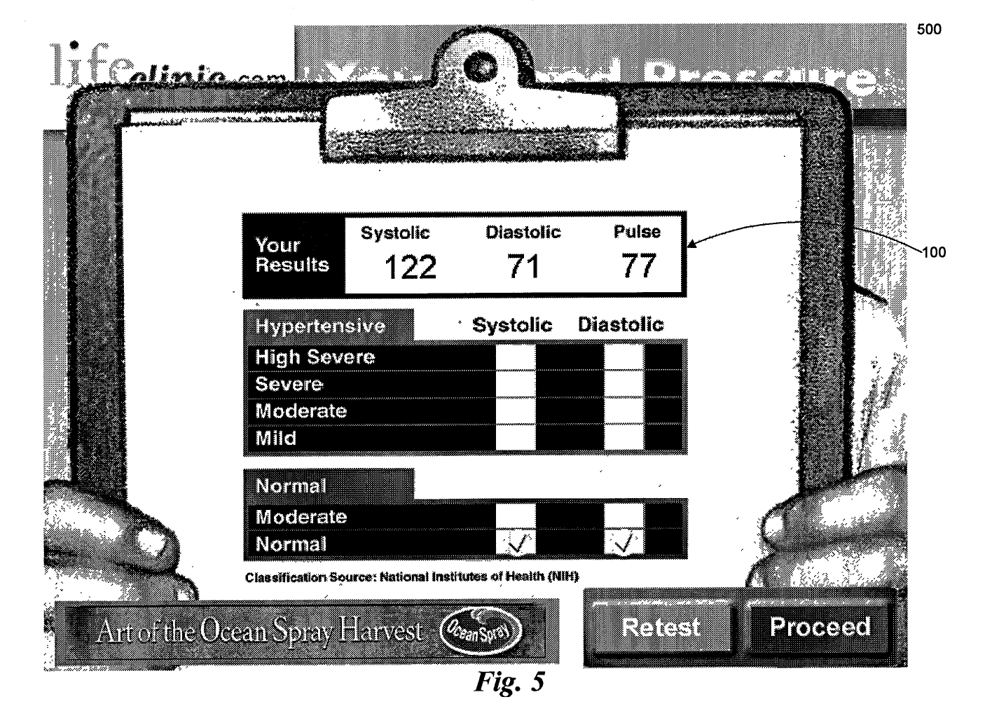

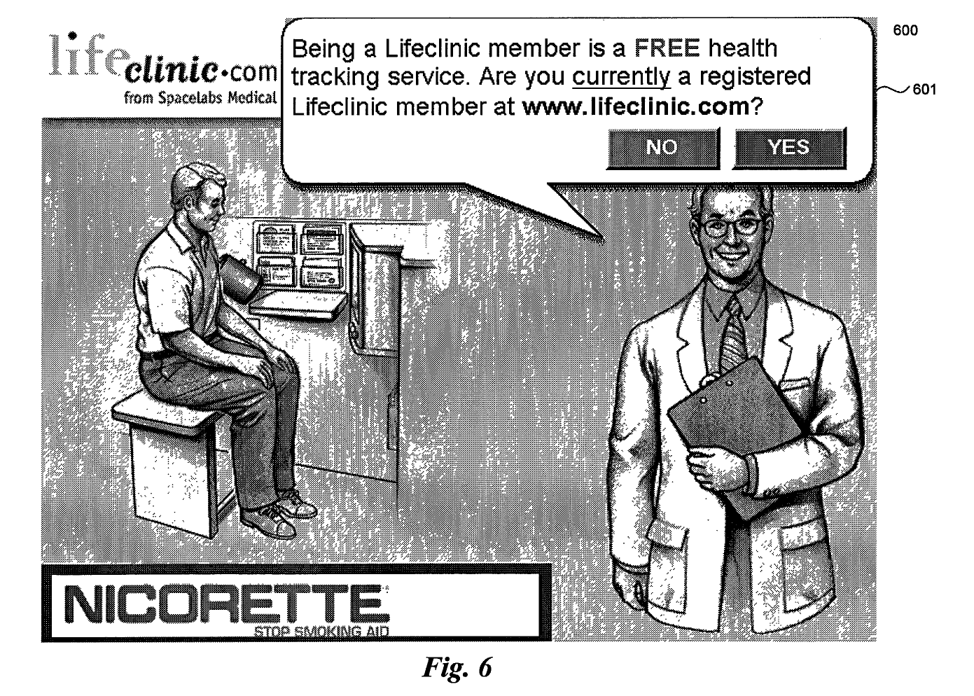

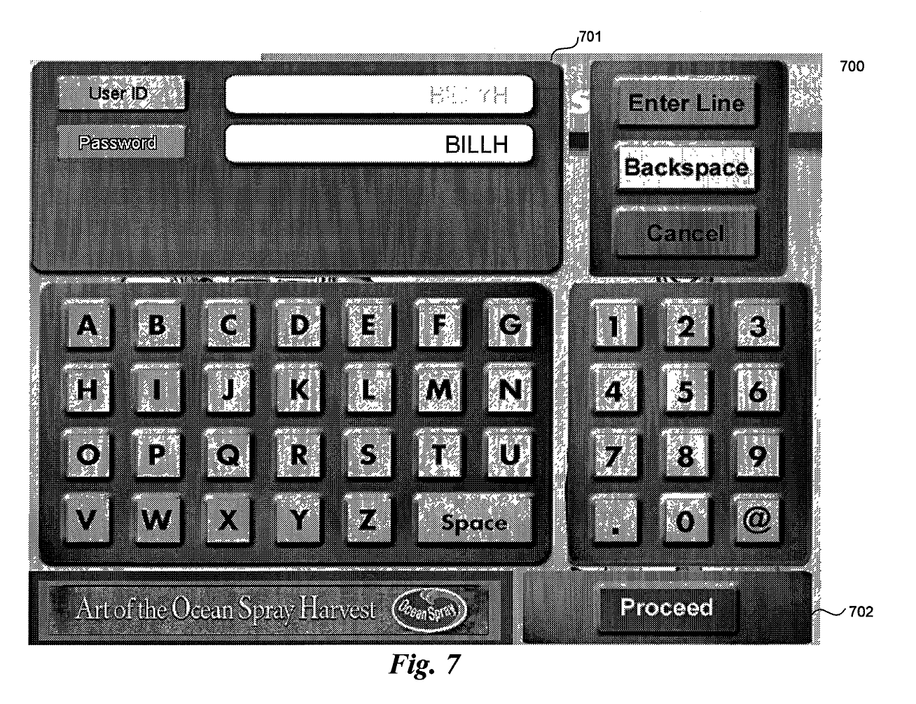

FIGS. 1-7 are diagrams illustrating the user interface of a collection kiosk in one embodiment. FIG. 1 is a diagram illustrating the main web page of the collection kiosk. The medical information web site in this embodiment is Lifeclinic.com. Web page 100 includes a general information area 101, a take blood pressure link 102, and a review health record link 103. This web page may be displayed when a user first starts to collect their medical information. The general information area describes how to become a member or registered user of Lifeclinic.com and how to use the collection kiosk. A user can select the take blood pressure link to proceed with taking their blood pressure and select the review health record link to view their medical information that has been collected at this collection kiosk. FIG. 2 is a diagram illustrating a blood pressure verification web page. Web page 200 includes dialog box 201 with buttons to verify whether the user wants to proceed with having their blood pressure measured. FIG. 3 is a diagram illustrating an instructional web page. Web page 300 includes dialog box 301. The dialog box provides instructions for taking blood pressure and includes a start button that the user selects when the user is ready to start taking their blood pressure. FIG. 4 is a diagram illustrating a web page displayed while collecting blood pressure measurements. Web page 400 includes general information about the taking of blood pressure. FIG. 5 is a diagram illustrating a web page for displaying blood pressure measurements. Web page 500 includes blood pressure display box 501 in which the recently taken blood pressure information is displayed. FIG. 6 is a diagram illustrating a web page asking the user whether to save the measurements. Web page 600 includes dialog box 601. The dialog box 601 contains information asking the user whether they want to save these measurements as a registered Lifeclinic.com user and includes buttons for indicating a response. FIG. 7 is a diagram illustrating a web page for entry of log on information of a registered user. This web page is displayed when a user indicates that they want to save these measurements. Web page 700 includes log on area 701. A user enters their user identifier and password in the log on area and then selects the proceed button 702. The collection kiosk can then determines whether the user is registered by checking its own copy of the list of registered users. The collection kiosk then stores the user's recently taken blood pressure information so that it may be eventually uploaded to the medical information server. If the user is not currently registered, then the collection kiosk stores the user identifier and password so that the user can be registered when blood pressure information is uploaded.

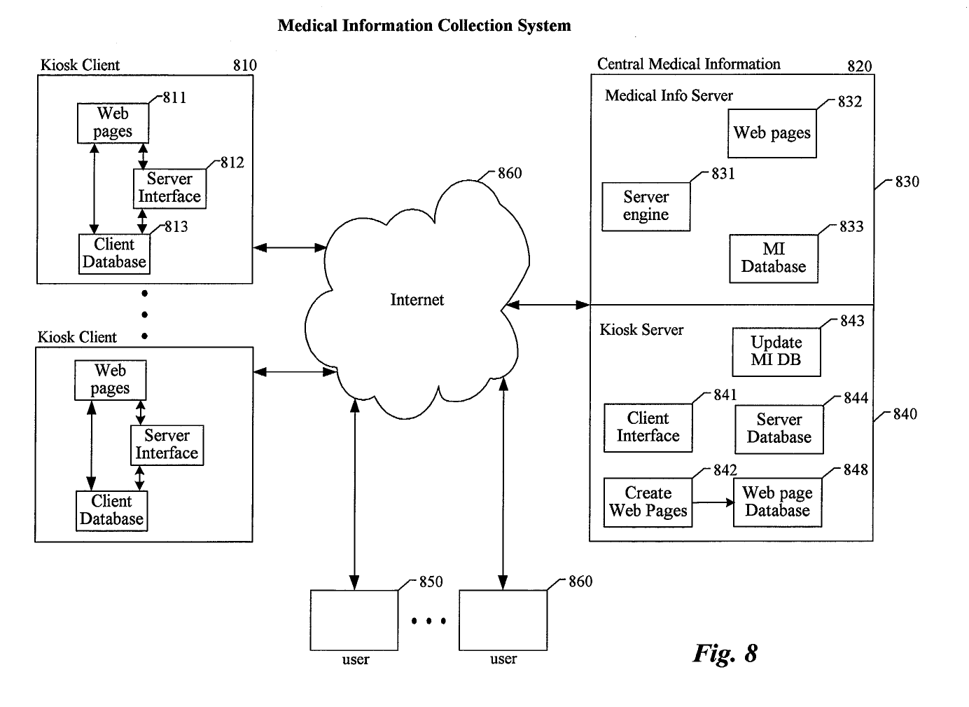

FIG. 8 is a block diagram illustrating components of a medical information collection system in one embodiment. The kiosk clients 810, the medical information system 820, and user computers 850 are interconnected via the Internet 860. The computers may include a central processing unit, memory, input devices (e.g., keyboard and pointing device), output devices (e.g., display devices), and storage devices (e.g., disk drives). The memory and storage devices are computer-readable medium that may contain computer instructions that implement the medical information collection system. In addition, the data structures and message structures may be stored or transmitted via a signal transmitted on a computer-readable media, such as a communications link. The user computers may use browsers to access web pages of the central medical information system via the Internet. One skilled in the art will appreciate that the concepts of the medical information collection system can be used in many different environments. Also, various communication channels other than the Internet may be used, such as a local area network, a wide area network, or a point-to-point dial-up connection. The computer systems may comprise any combination of hardware and software that can support web servers and browsers. In particular, the central medical information system may comprise multiple computers. The user computers may comprise any combination of hardware software that interacts with server systems.

The kiosk clients, which are implemented at the collection kiosks, include a web browser (not shown), web pages 811, a server interface 812, and a client database 813. The web pages define the user interface for the collection kiosks. The description of these web pages (e.g., HTML documents) along with additional content (e.g., .gif files) may be stored in a certain directory of the file system. A user of the collection kiosk uses the browser to browse the various web pages. The server interface is responsible for accessing the central medical information system to retrieve updated content and registered user updates. In one embodiment, the server interface acts as an FTP client to retrieve updated content and user updates from the central medical information system. The server interface may periodically (e.g., daily) established an FTP connection to retrieve the updated content and user information. The server interface stores the updated content in the web page directory to overwrite or augment existing web page content or updates a registered user table to reflect the updated user information. The client database thus contains the identification of each of the users of the central medical information system along with the medical information collected at that collection kiosk.

The central medical information system includes a medical information server 830 (e.g., Lifeclinic.com) and a kiosk server 840. The medical information server provides web pages through which users can view their medical information stored at the central medical information system. The medical information server includes a server engine 831, web pages 832, and medical information database 833. The server engine receives and responds to HTTP requests. The web pages define the user interface that is provided to the user computers. The medical information database contains the identification of the users and the collected medical data for each user. The kiosk server controls the distribution of content and update of registered user to the kiosk clients. The kiosk server includes a client interface 841, a create web page component 842, an update medical information database 843, a server database 844, and a web page database 845. The client interface includes a component to move content and user udpates to be distributed to kiosk clients through various FTP directories and an FTP server to provide the updated content and user udpates when requested by the FTP clients of the kiosk clients. The create web page component allows an administrator to specify the content of the various web pages and to specify which content should be distributed to which kiosk clients. The web page database contains the description of web pages and their content. The server database contains access information (e.g., URLs) for the kiosk clients. The update medical information database contains the medical information collected via the collection kiosks and awaiting to be stored in the medical information database of the medical information server.

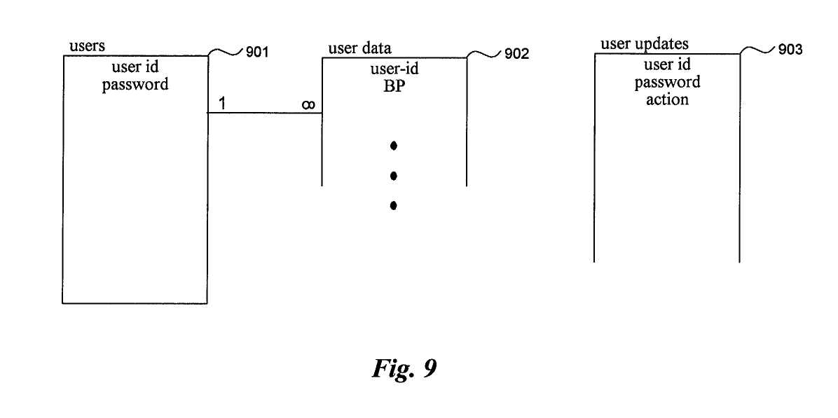

FIG. 9 is a block diagram illustrating data structures of the medical information database. The database includes a user table 901, a user data table 902, and a user update table 903. The medical information server stores an entry in the user table for each registered Lifeclinic.com user. The user table may contain a user identifier and password. This information can be used to verify whether a user who is logging on to Lifeclinic.com is registered. The user data table contains the medical information and other information (e.g., address) for each registered user. Whenever the medical information server updates the user table, it adds an entry into the user update table that reflects the update made to the user table. For example, when a new registered user is added to the user table, the medical information server adds an entry into the user update table that indicates the user identifier and password of the new user and that indicates an add action.

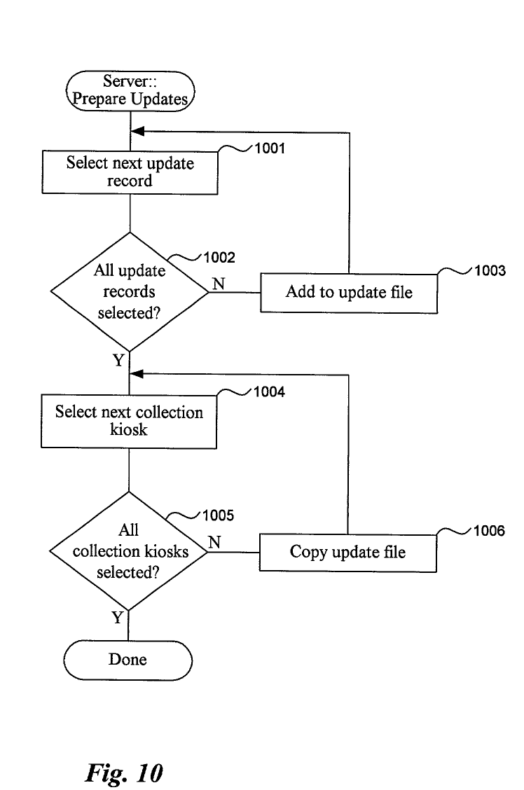

FIG. 10 is a flow diagram of a routine of the kiosk server that prepares the update files for transmission to the collection kiosk. This routine retrieves the records from the user update table of the medical information server and creates an update file. The routine then copies that update file to the FTP directory for each collection kiosk. In blocks 1001-1003, the routine loops adding each update record to the update file. In block 1001, the routine selects the next update record from the user update table. In decision block 1002, if all the update records have already been selected, then the routine continues at block 1004, else the routine continues at block 1003. In block 1003, the routine adds the selected record to the update file and loops to block 1001 to select the next update record. In blocks 1004-1006, the routine loops copying the update file to the FTP directories for the collection kiosks. In block 1004, the routine selects the next collection kiosk. In decision block 1005, if all the collection kiosks have already been selected, then the routine completes, else the routine continues at block 1006. In block 1006, the routine copies the update file to the FTP directory for the selected collection kiosk and then loops to block 1004 to select the next collection kiosk.

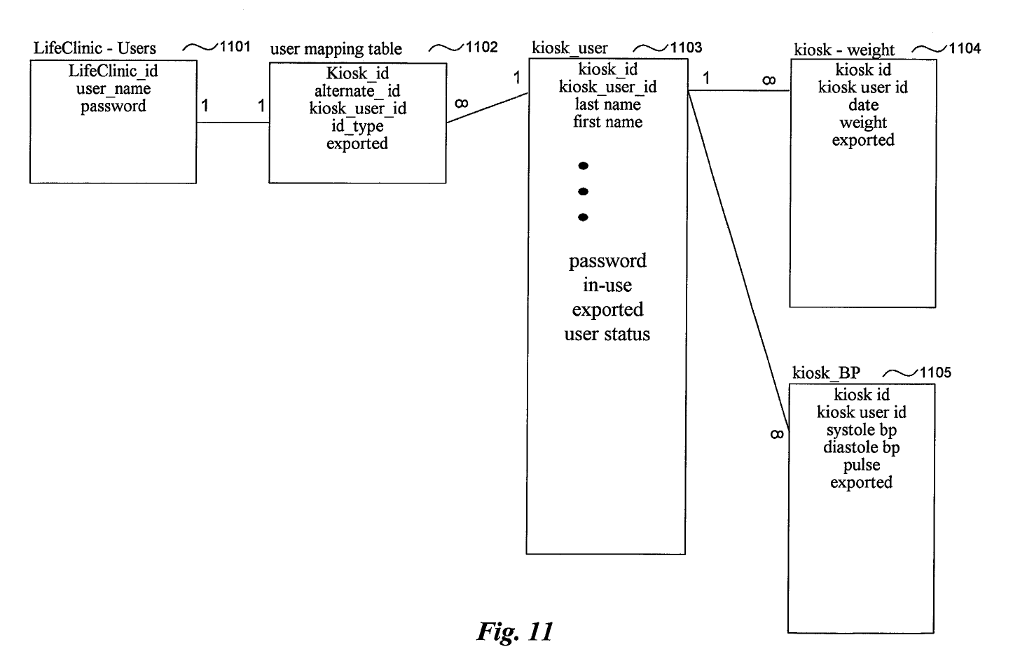

FIG. 11 is a block diagram illustrating data structures of the database of a collection kiosk in one embodiment. The collection kiosk includes a Lifeclinic user table 1101, a user mapping table 1102, a kiosk user table 1103, a kiosk weight table 1104, and a kiosk blood pressure table 1105. The Lifeclinic user table contains an entry for each registered Lifeclinic.com user. The collection kiosk updates the Lifeclinic user table when processing the update files that it retrieves from the kiosk server. The kiosk user table contains an entry for each user who has used this collection kiosk. The user mapping table contains a mapping from Lifeclinic user identifier to kiosk user identifier. That is, each Lifeclinic user who has used this collection kiosk will have a corresponding entry in the user mapped table that maps their Lifeclinic identifier to their kiosk identifier. The kiosk weight table and kiosk blood pressure table contain an entry for each blood pressure reading and weight reading for the users.

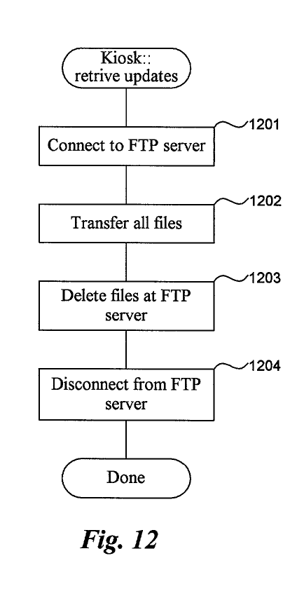

FIG. 12 is a flow diagram of a routine to retrieve the update files from the server. This routine uses the FTP protocol to transfer the file. One skilled in the art would appreciate that alternative communication protocols may be used. For example, the updates to the registered user information can be distributed dynamically to the collection kiosk as the information is updated using the HTTP protocol. This routine may be invoked on a periodic basis, such as a daily basis, to retrieve the update file. In block 1201, the routine connects to the FTP server of the kiosk server. In block 1202, the routine requests that all files in the directory for this collection kiosk be transferred from the kiosk server to the collection kiosk. In block 1202, the routine requests that all the update files in the directory for this collection kiosk at the FTP server be deleted so that the files are not retrieved again. In block 1204, the routine disconnects from the FTP server and then completes.

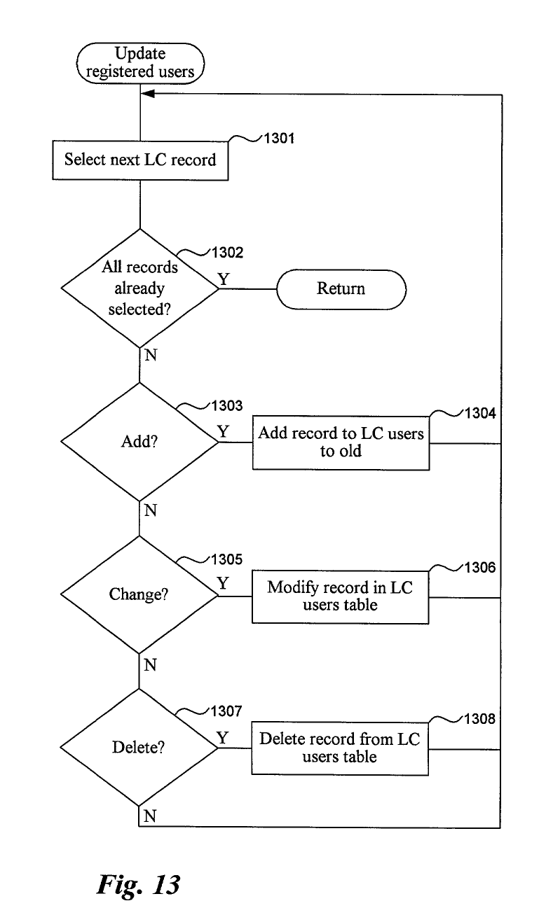

FIG. 13 is a flow diagram illustrating the processing of an update file. This routine retrieves the update records from the update file and updates the Lifeclinic user table at the collection kiosk accordingly. This routine may be invoked on a periodic basis, such as daily, or after transfer of an update file from the kiosk server to the collection kiosk. In block 1301, the routine selects the next update record from the update file. In decision block 1302, if all the records have already been selected, then the routine completes, else the routine continues at block 1303. In decision block 1303, if the selected record indicates to add a new Lifeclinic user, then the routine continues at block 1304, else the routine continues at block 1305. In block 1304, the routine adds a record to the Lifeclinic user table reflecting the new user and loops to block 1301 to select the next record. In decision block 1305, if the selected record indicates to change the information for a Lifeclinic user, then the routine continues at block 1306, else the routine continues at block 1307. In block 1306, the routine modifies a record in the Lifeclinic user table to reflect the change and then loops to block 1301 to select the next record. The routine may also need to update the information in the user mapping table if, for example, the user name field was modified. In decision block 1307, if the selected record indicates to delete a Lifeclinic user, then the routine continues at block 1308, else the routine loops to block 1301 to select the next update record. In block 1308, the routine deletes the appropriate record from the Lifeclinic user table and loops to block 1301 to select the next update record.

Tables 1-5 illustrate the schema of a client database stored at the collections kiosks. Table 1 represents the Lifeclinic user table and contains an entry for each Lifeclinic user. Table 2 represents the kiosk user table. This table holds basic information about a kiosk user. It contains an entry for each user of the collection kiosk. Table 3 maps Lifeclinic users to collections kiosk users. Table 4 represents the blood pressure table. Table 5 represents the kiosk weight table, which holds the weight readings taken by the collection kiosks.

TABLE 1
LIFECLINIC USER TABLE

| column | type | description |
|---|---|---|
| lifeclinic_id | text | The user's lifeclinic_id. This number is used to |
| | | internally identify the user. All of a user's data is |
| | | stored under this identifier |
| user_name | text | The name that the user uses to logon on with at |
| | | the Lifeclinic web site. |
| password | text | The password used by the user at Lifeclinic.com |

TABLE 2
KIOSK USER TABLE

| column | type | description |
|---|---|---|
| kiosk_id | number | The identification of the collection kiosk |
| kiosk_user_id | number | Unique identifier for a kiosk user. Used |
| | | internally to key user's data. |
| first_name | text | User's first name. |
| last_name | text | User's last name. |
| exported | Boolean | Indicates if this user's data has been moved |
| | | to the Lifeclinic web site. |
| user_status | number | Indicates user type. Possible values are 1 - |
| | | kiosk only, 2 - a kiosk and a Lifeclinic user, |
| | | 3 - a kiosk user who is to automatically |
| | | register as a Lifeclinic user. |

TABLE 3
USER MAPPING TABLE

| column | type | description |
|---|---|---|
| kiosk_id | number | The identification of the collection kiosk |
| alternate_id | text | An identifier that a user can use to logon with. |
| | | This identifier can be anything, such as a credit |
| | | card number, a user supplied identifier, or a |
| | | Lifeclinic id. |
| kiosk_user_id | text | The kiosk user who the alternate_id maps to. |
| id_type | number | Type of identifier stored in alternate_id. |
| | | Possible values are 0 - kiosk_user_id, |
| | | 1 - lifeclinic_id, 2 - other, 3 - login |
| | | information used to register a new |
| | | lifeclinic.com user, 4 - login information |
| | | rejected by the lifeclinic.com server. |
| exported | Boolean | Indicates if this user's data has been moved to |
| | | the Lifeclinic web site. |

TABLE 4
BLOOD PRESSURE TABLE

| column | type | description |
|---|---|---|
| kiosk_id | number | The identification of the collection kiosk |
| kiosk_user_id | number | Identifier of kiosk user to whom reading |
| | | belongs. |
| reading_dt | date | The date and time the reading was taken |
| systolic_bp | number | Systolic blood pressure reading. |
| diastolic_bp | number | Diastolic blood pressure reading. |
| pulse | number | Pulse rate reading. |
| exported | Boolean | Indicates if data has been moved to the |
| | | Lifeclinic web sites. |

TABLE 5
KIOSK WEIGHT TABLE

| column | type | description |
|---|---|---|
| kiosk_id | number | The identification of the collection |
| kiosk_user_id | number | Identifier of kiosk user to whom reading |
| | | belongs. |
| reading_dt | date | The date and time the reading was taken |
| weight | number | Weight reading in pounds. |
| exported | Boolean | Indicates if data has been moved to |
| | | Lifeclinic.com |

Based on the above description, it will be appreciated that although various embodiments of the technology have been described for purposes of illustration, various modifications may be made without deviating from the spirit and scope of the invention. Accordingly, the invention is not limited except by the appended claims.

1. A method in a computer system for distributing user information for registered users from the computer system to collection kiosks, the method comprising:
providing user information for registered users;
receiving updates to the user information;
generating update user information;
for each of the collection kiosks,
receiving a request from the collection kiosk for the generated update user information;
sending to the requesting collection kiosk the update user information
wherein the collection kiosks use the update user information to verify whether a user is registered.

2. The method of claim 1 wherein the collection kiosks operate as FTP clients and the computer system operates as an FTP server.

3. The method of claim 1 wherein the received update user information includes indications of whether to add a registered user, delete a registered user, or change information relating to a registered user.

4. The method of claim 1 wherein a collection kiosk sends a request for the generated update user information once a day.

5. The method of claim 1 wherein the user information includes a user identifier and a password.

6. A method in a collection kiosk for retrieving updated user information, the method comprising:
providing user information for registered users;
sending a request for updated user information;
in response to sending the request, receiving the updated user information; and
updating the provided user information for the registered user in accordance with the received updated user information so that the collection kiosk can verify whether a user of the collection kiosk is registered.

7. An information collection system comprising:
a central computer system for a web site, the central computer system providing a repository for the information, web pages for registering users of the web site, and for accessing the information; and
a plurality of collection kiosks for collecting information about users, for verifying whether a user is registered at the web site, and for sending the collected information to the central computer system when the user is registered.

8. The information system of claim 7 wherein the information is medical information.

9. A computer-based method for collecting medical information of users of a web site, the method comprising:
registering the users at the web site when information about a user is collected at one of a plurality of collection kiosks,
determining whether the user is registered at the website; and
when registered, sending the collected information to a computer system so that the collected information is accessible to the user through the web site.
